(19) United States
(12) Patent Application Publication
(10) Pub. No.: US 2026/0104350 A1
(43) Pub. Date: Apr. 16, 2026

(54) LASER INDUCED ULTRASONIC INSPECTION APPARATUS, DISPLAY APPARATUS, ELECTRONIC INSTRUMENT, AND VEHICLE

(71) Applicant: SEIKO EPSON CORPORATION, TOKYO (JP)

(72) Inventors: Kohei YAMADA, SHIOJIRI-SHI (JP); Shoichi TAKASUNA, SHIOJIRI-SHI (JP)

(21) Appl. No.: 19/332,245

(22) Filed: Sep. 18, 2025

(30) Foreign Application Priority Data
Sep. 18, 2024 (JP) 2024-161450

(51) Int. Cl. G01N 21/17; G01B 11/06; G01N 21/88; G06T 7/00; G06T 7/60; G06T 7/70

(52) U.S. Cl. CPC G01N 21/1702; G01B 11/06; G01N 21/88; G06T 7/0004; G06T 7/60; G06T 7/70; G01N 2021/1706; G06T 2207/10032; G06T 2207/10132; G06T 2207/30108; G06T 2207/30252

(57) ABSTRACT

A laser induced ultrasonic inspection apparatus including: a first laser light source configured to irradiate pulse-shaped first laser light; a laser interferometer configured to detect, by using second laser light, vibration of an object; an imager configured to capture a irradiation position of the first laser light and the object; and an enclosure, the laser interferometer including a light modulator configured to modulate a frequency of the second laser light by using a vibrator; and a light receiver configured to receive light as a result of interference between the second laser light traveling via the object and the second laser light traveling via the light modulator, the vibrator being a signal source of a reference signal, the first laser light source being configured to output the first laser light based on the reference signal, and the imager being configured to perform the imaging based on the reference signal.

The present application is based on, and claims priority from JP Application Serial Number 2024-161450, filed Sep. 18, 2024, the disclosure of which is hereby incorporated by reference herein in its entirety.

### BACKGROUND

### 1. Technical Field

The present disclosure relates to a laser induced ultrasonic inspection apparatus, a display apparatus, an electronic instrument, and a vehicle.

### 2. Related Art

JP-A-04-147053 discloses a laser induced ultrasonic flaw detection method for irradiating a reflective vibrating plate with pulse-shaped, ultrasonic wave generating laser light to generate an ultrasonic wave in the reflective vibrating plate, transmitting the generated ultrasonic wave to an object under inspection, causing the reflective vibrating plate to receive the ultrasonic wave reflected off the location of a defect in the object under inspection, and using ultrasonic wave detecting laser light to detect vibration of the reflective vibrating plate resulting from the received ultrasonic wave.

JP-A-09-281085 discloses that a laser induced ultrasonic inspection apparatus irradiates an object under inspection with a laser beam to generate an ultrasonic wave, and detects vibration of the object under inspection produced by the generated ultrasonic wave with a laser interferometer. The thus configured laser induced ultrasonic inspection apparatus allows improvement in the distance resolution in determination of the position of a defect in the object under inspection.

JP-A-04-147053 and JP-A-09-281085 are examples of the related art.

The laser induced ultrasonic inspection apparatus of the related art has a large number of parts, and it is therefore difficult to reduce the size of the inspection apparatus. The laser induced ultrasonic inspection apparatus of the related art therefore has poor portability, and is therefore not assumed, for example, to inspect an object under inspection with the inspection apparatus held by hand.

It is therefore an object to realize a laser induced ultrasonic inspection apparatus that has a small number of parts, is readily reduced in size, and excels in portability.

### SUMMARY

A laser induced ultrasonic inspection apparatus according to an application example of the present disclosure including:
a first laser light source configured to irradiate an object under inspection with pulse-shaped first laser light;
a laser interferometer configured to detect, by using second laser light, vibration of the object under inspection derived from an ultrasonic wave induced in the object under inspection by the radiation of the first laser light;
an imager configured to capture a irradiation position of the first laser light and the object under inspection; and
an enclosure configured to house the first laser light source, the laser interferometer, and the imager,
wherein the laser interferometer includes
a second laser light source configured to irradiate the object under inspection with the second laser light,
a light modulator configured to modulate a frequency of the second laser light by using a vibrator; and
a light receiver configured to receive light as a result of interference between the second laser light traveling via the object under inspection and the second laser light traveling via the light modulator and output a light reception signal,
the vibrator is a signal source of a reference signal,
the first laser light source is configured to output the first laser light based on the reference signal, and
the imager is configured to perform the imaging based on the reference signal.

A display apparatus according to another application example of the present disclosure including:
the laser induced ultrasonic inspection apparatus according to the application example of the present disclosure; and
a display configured to display a distribution map of defects detected by laser induced ultrasonic inspection apparatus.

An electronic instrument according to another application example of the present disclosure including
the laser induced ultrasonic inspection apparatus according to the application example of the present disclosure.

A vehicle according to another application example of the present disclosure including
the laser induced ultrasonic inspection apparatus according to the application example of the present disclosure.

### BRIEF DESCRIPTION OF THE DRAWINGS

FIG. 1 is a block diagram showing a schematic configuration of a laser induced ultrasonic inspection apparatus according to a first embodiment.

FIG. 2 is an example of the circuit diagram of a frequency converter including an n-base counter.

FIG. 3 is a timing chart showing an example of a reference signal input to a signal processor, a displacement calculated from a light reception signal, a laser sensing signal, and an imaging control signal.

FIG. 4 is a diagrammatic view showing a state in which the optical axis of second laser light inclines by a deviation angle d with respect to a reference line parallel to the optical axis of first laser light.

FIG. 5 is a diagrammatic view showing a case where the optical axis of the first laser light and the optical axis of the second laser light are made coaxial by using a coaxial optical system.

FIG. 6 shows an example of a combined image in a case where an object under inspection is a bottle.

FIG. 7 is a diagrammatic view showing propagation of ultrasonic waves induced when two of first laser light are irradiated onto two different locations at a surface of the object under inspection.

FIG. 8 shows an example of a scanning-operation trajectory of a irradiation position of the first laser light as a result of scanning the object under inspection with the first laser light, and an example of a defect distribution map produced by replacing the length of an elapsed period on the scanning-operation trajectory with a color density and mapping the color density.

FIG. 9 is a diagrammatic view showing a schematic configuration of a laser induced ultrasonic inspection apparatus according to a second embodiment.

FIG. 10 is a diagrammatic view showing a schematic configuration of a laser induced ultrasonic inspection apparatus according to a third embodiment.

FIG. 11 is a graph showing the waveform of the displacement of the object under inspection produced in association with vibration.

FIG. 12 shows an example of the scanning-operation trajectory of the irradiation position of the first laser light as a result of scanning the object under inspection with the first laser light, and an example of a defect distribution map produced by replacing a frequency analysis result on the scanning-operation trajectory with a color density and mapping the color density.

FIG. 13 is a diagrammatic view showing a schematic configuration of a display apparatus according to a fourth embodiment.

FIG. 14 is a perspective view showing a state in which the display apparatus shown in FIG. 13 is used to inspect the object under inspection.

FIG. 15 shows an example of a defect distribution map displayed on a display shown in FIG. 13, and the object under inspection viewed through the display and superimposed on the defect distribution map.

FIG. 16 is an example of the defect distribution map displayed on the display shown in FIG. 13.

FIG. 17 is a diagrammatic view showing a schematic configuration of an electronic instrument according to a fifth embodiment.

FIG. 18 is a diagrammatic view showing a schematic configuration of another electronic instrument according to the fifth embodiment.

FIG. 19 is a diagrammatic view showing a schematic configuration of a vehicle according to a sixth embodiment.

FIG. 20 is a diagrammatic view showing a schematic configuration of another vehicle according to the sixth embodiment.

FIG. 21 is a diagrammatic view showing a schematic configuration of another vehicle according to the sixth embodiment.

FIG. 22 is a block diagram showing a schematic configuration of a laser induced ultrasonic inspection apparatus of related art.

### DESCRIPTION OF EMBODIMENTS

A laser induced ultrasonic inspection apparatus, a display apparatus, an electronic instrument, and a vehicle according to aspects of the present disclosure will be described below in detail based on embodiments shown in the accompanying drawings.

### 1. Related Art

A related art will first be described.

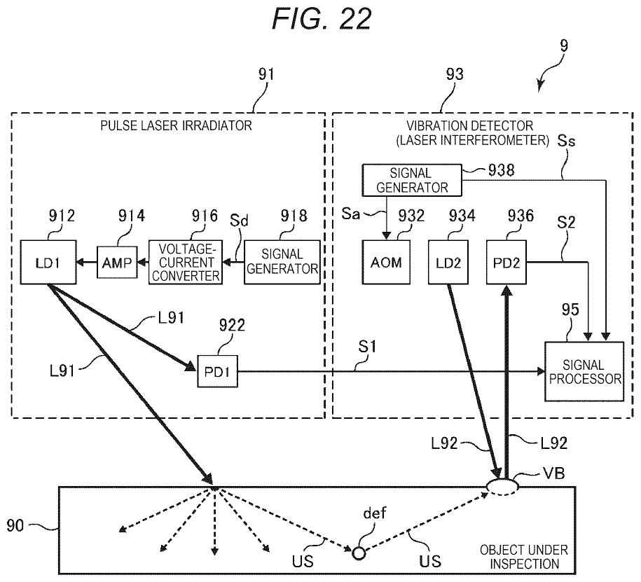

FIG. 22 is a block diagram showing a schematic configuration of a laser induced ultrasonic inspection apparatus 9 of the related art.

The laser induced ultrasonic inspection apparatus 9 illustrated in FIG. 22 includes a pulse laser irradiator 91 and a vibration detector 93 (laser interferometer).

The pulse laser irradiator 91 includes a laser light source 912, an amplifier 914, a voltage-current converter 916, a signal generator 918, and a photodiode 922.

The signal generator 918 generates a pulse control signal Sd. The voltage-current converter 916 converts the pulse control signal Sd, which is a pulse-shaped voltage signal, into a current signal. The amplifier 914 amplifies the current signal and supplies the amplified current signal to the laser light source 912. The pulse laser irradiator 91 then irradiates an object under inspection 90 with laser light L91 output from the laser light source 912. An ultrasonic wave US is thus induced in the object under inspection 90. The generated ultrasonic wave US propagates in the object under inspection 90, and when there is a defect def in the object under inspection 90, the ultrasonic wave US is reflected there and reaches a surface of the object under inspection 90. The ultrasonic wave US having reached the surface induces vibration VB of the surface. The photodiode 922 receives part of the laser light L91 and generates a laser sensing signal S1.

The vibration detector 93 is a laser interferometer, and includes an acousto-optical modulator (AOM) 932, a laser light source 934, a photodiode 936, a signal generator 938, and a signal processor 95.

The signal generator 938 generates a drive signal Sa, which is necessary for the operation of the acousto-optical modulator 932, and a reference signal Ss, which serves as a time reference for multiple types of signal processing in the signal processor 95. The vibration detector 93 irradiates the object under inspection 90 with laser light L92 output from the laser light source 934. The laser light L92 is thus subjected to a Doppler shift due to the vibration VB of the surface. Thereafter, the photodiode 936 receives the laser light L92 having been subjected to the Doppler shift and the laser light L92 having passed through the acousto-optical modulator 932, and outputs a light reception signal S2. The vibration VB is electrically detected through measurement of the Doppler shift based on the optical interference effect.

Based on the laser sensing signal S1 output from the photodiode 922, the light reception signal S2 output from the photodiode 936, and the reference signal Ss output from the signal generator 938, the signal processor 95 calculates an elapsed period Δt from the output of the laser light L91 to the detection of the vibration VB. The elapsed period Δt reflects the position of a reflection point where the ultrasonic wave US is reflected. The signal processor 95 determines whether the defect def is present and the position thereof based on the elapsed period Δt.

The signal generator 938 provided in the vibration detector 93, however, causes an increase in the number of parts of the laser induced ultrasonic inspection apparatus 9. In particular, a light modulator such as the acousto-optical modulator 932 (AOM) or an electro-optical modulator (EOM) that is not shown has a large size in itself and consumes a large amount of power. Therefore, the signal generator 938, which supplies the drive signal Sa to any of the light modulators described above, inevitably increases the number of parts and the size of the laser induced ultrasonic inspection apparatus 9, so that the laser induced ultrasonic inspection apparatus 9 of the related art is unlikely to be reduced in size and has poor portability.

To avoid the problems described above, in each embodiment that will be described later, a light modulator using a vibrator is provided to achieve, for example, reduction in the number of parts, the size, the power consumption of a vibration detector (laser interferometer). A laser induced ultrasonic inspection apparatus that is readily reduced in size and excels in portability can thus be achieved.

### 2. First Embodiment

A laser induced ultrasonic inspection apparatus according to a first embodiment will next be described.

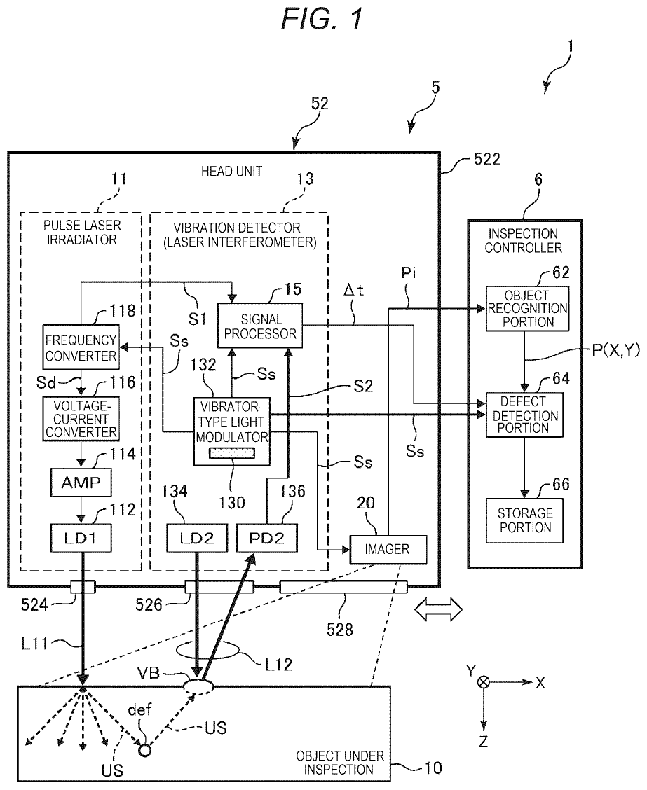

FIG. 1 is a block diagram showing a schematic configuration of a laser induced ultrasonic inspection apparatus 1 according to the first embodiment.

The laser induced ultrasonic inspection apparatus 1 shown in FIG. 1 includes a head unit 5 and an inspection controller 6. The head unit 5 is portable, and has a size and a weight that allow, for example, an operator to hold the head unit 5 and move it to any position. The inspection controller 6 is, for example, installed at any position. The head unit 5 and the inspection controller 6 can communicate with each other by wire or wirelessly. The laser induced ultrasonic inspection apparatus 1 shown in FIG. 1 inspects an object under inspection 10 by detecting whether the object under inspection 10 has a defect def and the position thereof.

### 2.1. Overview of Head Unit

The head unit 5 shown in FIG. 1 includes a pulse laser irradiator 11, a vibration detector 13, an imager 20, and an enclosure 52.

The pulse laser irradiator 11 is disposed in the enclosure 52. The pulse laser irradiator 11 includes a first laser light source 112, an amplifier 114, a voltage-current converter 116, and a frequency converter 118. In the pulse laser irradiator 11, the first laser light source 112 outputs pulse-shaped first laser light L11 based on a pulse control signal Sd output from the frequency converter 118. The object under inspection 10 is then irirradiated with the pulse-shaped first laser light L11 output from the first laser light source 112. An ultrasonic wave US is thus induced in the object under inspection 10. The generated ultrasonic wave US radially propagates in the object under inspection 10, and when the object under inspection 10 has the defect def, the ultrasonic wave US is reflected there and reaches a surface of the object under inspection 10. The ultrasonic wave US having reached the surface induces vibration VB accompanied by a displacement of the surface.

The vibration detector 13 is disposed in the enclosure 52. The vibration detector 13 is a laser interferometer, and includes a light modulator 132 using a vibrator 130, a second laser light source 134, a photodiode 136 (light receiver), and a signal processor 15. The vibration detector 13 irradiates the object under inspection 10 with second laser light L12 output from the second laser light source 134. The irradiated second laser light L12 is subjected to a Doppler shift due to the vibration VB of the surface of the object under inspection 10. The second laser light L12 having been subjected to the Doppler shift is then received by the photodiode 136. The vibration VB is electrically detected by using an optical heterodyne method to measure the Doppler shift with the aid of the interference effect of the second laser light L12.

Specifically, the second laser light L12 output from the second laser light source 134 is, for example, split into two parts by a light splitter that is not shown, one of the two parts being incident on the light modulator 132, and the other being incident on the object under inspection 10. The light modulator 132 modulates the frequency of the second laser light L12, and generates reference light containing a modulation signal. In the object under inspection 10, the second laser light L12 is subjected to the Doppler shift, and object light containing a surface vibration signal is generated. The reference light and the object light are caused to interfere with each other, and the resultant light is received by the photodiode 136. The light reception signal S2 containing the modulation signal and the surface vibration signal is thus output from the photodiode 136. The signal processor 15 demodulates the surface vibration signal from the light reception signal S2, and calculates the displacement and displacement speed of the surface of the object under inspection 10.

The light modulator 132 uses the vibration of the vibrator 130 to impart the modulation signal to the second laser light L12, and uses the vibrator 130 as a signal source to generate the reference signal Ss. The light modulator 132 includes a vibrator oscillation circuit that is not shown but causes the vibrator 130 to oscillate. The vibrator oscillation circuit can be configured with a small number of parts, so that the reference signal Ss can be generated with a significant increase in the number of parts avoided. Furthermore, a low voltage allows the vibrator 130 to oscillate, so that the power consumption of the vibrator oscillation circuit can be suppressed to a low level. The laser induced ultrasonic inspection apparatus 1 can therefore operate with an external power supply or even an internal power supply such as a primary battery or a secondary battery disposed in the enclosure 52. Furthermore, providing the light modulator 132 allows omission of the acousto-optical modulator 932 in the related art. The size and weight of the head unit 5 are thus reduced, so that the head unit 5 is portable.

The signal processor 15 acquires the laser sensing signal S1 output from the frequency converter 118, the light reception signal S2 output from the photodiode 136, and the reference signal Ss output from the light modulator 132. An elapsed period Δt from the output of the first laser light L11 to the detection of the vibration VB is then calculated based on the signals described above. The calculated elapsed period Δt is output toward the inspection controller 6.

The imager 20 is disposed in the enclosure 52. The imager 20 captures the irradiation position of the first laser light L11 and the object under inspection 10. The imager 20 includes an imaging element and an imaging controller none of which is shown.

Examples of the imaging element may include a CCD (charge coupled device) and a CMOS (complementary metal oxide semiconductor) device.

Although not shown, the imaging controller includes a drive control circuit that controls the operation of driving the imaging element, a signal processing circuit that processes a signal output from the imaging element, and the like. The drive control circuit controls the exposure start timing, the exposure period, and other parameters of the imaging element. The imaging timing and the exposure period are determined based on the reference signal Ss output from the light modulator 132. The signal processing circuit carries out necessary processes on the signal output from the imaging element to generate an image. The image shows the irradiation position of the first laser light L11 and the object under inspection 10. The generated image therefore includes information Pi on the irradiation position of the first laser light L11, as shown in FIG. 1. The image containing the irradiated position information Pi is output toward the inspection controller 6.

The reference signal Ss output from the light modulator 132 is input to the imager 20, the signal processor 15, and the inspection controller 6, and is used, for example, as a time reference for the operation of each of the elements described above. The signal generator 938 in the related art can therefore be omitted in the laser induced ultrasonic inspection apparatus 1. The size and weight of the head unit 5 are thus reduced, so that the head unit 5 is portable. Furthermore, based on the reference signal Ss, the elements described above can be operated in synchronization with each other readily and accurately. The laser induced ultrasonic inspection apparatus 1 therefore eventually inspects the object under inspection 10 with increased precision.

The enclosure 52 is a housing that houses the pulse laser irradiator 11, the vibration detector 13, the imager 20, and the like. Providing the enclosure 52 can improve the portability of the head unit 5. Furthermore, the housed elements can be protected from changes in external pressure and external environment.

Each portion of the laser induced ultrasonic inspection apparatus 1 will be described below in detail.

### 2.1.1. Pulse Laser Irradiator

The pulse laser irradiator 11 shown in FIG. 1 outputs the pulse-shaped first laser light L11 having a predetermined repetition frequency toward the object under inspection 10.

The first laser light source 112 outputs the pulse-shaped first laser light L11. Examples of the first laser light source 112 may include an Nd:YAG laser, a CO₂ laser, an Er:YAG laser, a titanium sapphire laser, an alexandrite laser, a ruby laser, a dye laser, a fiber laser, an excimer laser, and a semiconductor laser. Among the above, a semiconductor laser is preferably used. The semiconductor laser can contribute to reduction in size, weight, and power consumption of the first laser light source 112. Furthermore, the semiconductor laser can readily perform pulse oscillation through direct modulation, and can output the pulse-shaped first laser light L11 at low cost. In addition, the semiconductor laser may include as necessary a metal package or a ceramic package such as a CAN package that houses an element.

The repetition frequency of the pulse-shaped first laser light L11 is not limited to a specific frequency, but is preferably higher than or equal to 1 Hz but lower than or equal to 1000 Hz.

The pulse energy of the pulse-shaped first laser light L11 is set as appropriate in accordance with the material and other factors of the object under inspection 10 and is not limited to a specific value, but is preferably greater than or equal to 1 μJ/pulse, more preferably, greater than or equal to 10 μJ/pulse but smaller than or equal to 10 J/pulse. When the object under inspection 10 is a hard object such as a concrete block or a metal block, it is preferable to select high pulse energy of about 1 mJ/pulse, and when the object under inspection 10 is a soft object such as an object made of resin, it is preferable to select low pulse energy of about 1 μJ/pulse.

The amplifier 114 amplifies a current signal to be supplied to the first laser light source 112. Note that the amplifier 114 may be provided as necessary, and may be omitted when amplification is not necessary for driving the first laser light source 112.

The voltage-current converter 116 converts a voltage signal output from the frequency converter 118 into a current signal.

The reference signal Ss output from the light modulator 132 is input to the frequency converter 118. The frequency converter 118 generates the pulse control signal Sd based on the reference signal Ss. The pulse control signal Sd is converted by the voltage-current converter 116 into a current signal, which is supplied to the first laser light source 112 via the amplifier 114. In the first laser light source 112, the repetition cycle of the pulses of the first laser light L11 is determined based on the current signal. The frequency converter 118 includes, for example, a frequency dividing circuit that divides the frequency of the reference signal Ss by n, and an n-base counter. The parameter n represents a positive integer.

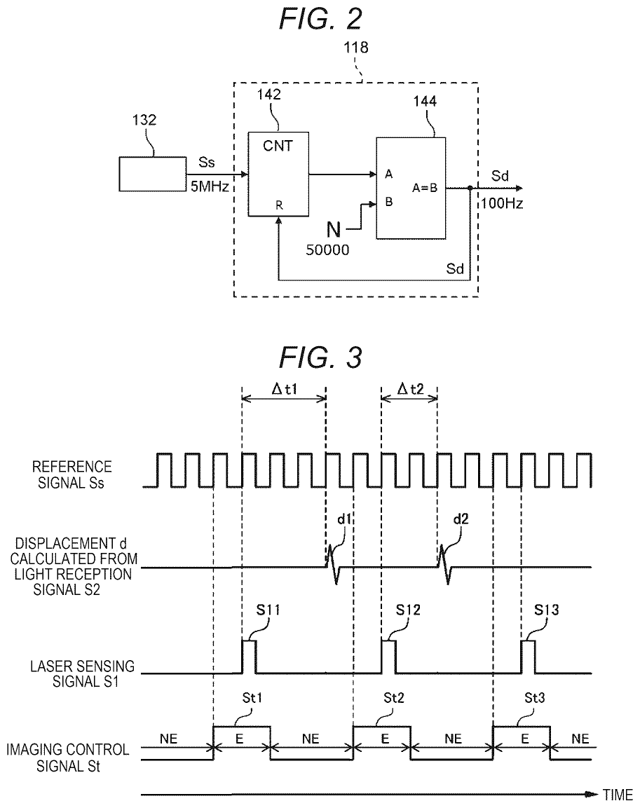

FIG. 2 is an example of the circuit diagram of the frequency converter 118 including an n-base counter. The frequency converter 118 shown in FIG. 2 includes a first circuit 142 and a second circuit 144.

The reference signal Ss output from the light modulator 132 is input to the first circuit 142. The first circuit 142 has the function of counting the pulses of the reference signal Ss and outputting the count. A pulse control signal Sd output from the second circuit 144 is input as a reset signal R to the first circuit 142. The first circuit 142 has the function of resetting the count to zero when the reset signal R is input thereto.

The count and a base number N are input to the second circuit 144. The base number N is set in accordance, for example, with the repetition frequency of the first laser light L11. The second circuit 144 has the function of outputting pulses when A=B is satisfied, where A represents the count, and B represents the base number N. The pulses serve as the pulse control signal Sd. A specific example of the above description may be a case where assuming that the frequency of the reference signal Ss is 5 MHz and the base number N is equal to 50000, the pulses of the pulse control signal Sd are output when the count becomes 50000. In this case, the frequency converter 118 performs down conversion of the frequency of 5 MHz of the reference signal Ss into 100 Hz, and outputs the resultant signal as the pulse control signal Sd.

Using the thus configured frequency converter 118 allows omission of the signal generator 918 in the related art. Since the frequency converter 118 described above can be configured with a relatively small number of parts, the number of parts can be further reduced in the laser induced ultrasonic inspection apparatus 1.

### 2.1.2. Vibration Detector

The vibration detector 13 shown in FIG. 1 detects the vibration VB generated at the surface of the object under inspection 10, and generates the light reception signal S2 containing the modulation signal and the surface vibration signal, as described above. The vibration detector 13 is preferably, for example, the laser interferometer disclosed in JP-A-2022-038156. The laser interferometer includes a light modulator using a vibrator and therefore contributes to reduction in size, weight, and power consumption of the vibration detector 13.

The light modulator 132 using the vibrator 130 may, for example, be the light modulator disclosed in JP-A-2022-038156. Examples of the vibrator 130 may include a quartz crystal vibrator, a silicon vibrator, and a ceramic vibrator. The quartz crystal vibrator may be an AT vibrator, a tuning-fork-type vibrator, or any other vibrator. The vibrators described above are vibrators that utilize a mechanical resonance phenomenon, and therefore each have a high Q-value and readily allow stabilization of the natural frequency. The S/N ratio (signal-to-noise ratio) of the modulation signal imparted to the second laser light L12 can therefore be readily increased. Furthermore, using a vibrator having a high Q-value as the vibrator 130 also allows an increase in the S/N ratio of the reference signal Ss generated by the light modulator 132, so that the S/N ratios of various signals based on the reference signal Ss can also be increased.

The second laser light source 134 may, for example, be any of the laser light sources disclosed in JP-A-2022-038156. Out of the disclosed laser light sources, using a semiconductor laser such as a vertical cavity surface emitting laser (VCSEL) allows further reduction in the size of the vibration detector 13.

The photodiode 136 (light receiver) receives light as a result of the interference between the reference light (second laser light L12 having traveled via light modulator 132) and the object light (second laser light L12 having traveled via object under inspection 10), and outputs the light reception signal S2.

The light modulator 132 uses the vibrator 130 to impart the modulation signal to the second laser light L12.

The light modulator 132 includes the vibrator oscillation circuit, which uses the vibrator 130 as the signal source to generate the reference signal Ss, as described above. Examples of the vibrator oscillation circuit may include an inverter-type oscillation circuit and a Colpitts-type oscillation circuit. The oscillation circuits described above can each generate a reference signal Ss that is highly stable in terms of frequency by using the vibrator 130 having a high Q-value for mechanical resonance. Furthermore, using the vibrator 130 as the signal source can reduce the power required for generation of the reference signal Ss, contributing also to reduction in power consumption of the vibration detector 13. Note that “using the vibrator 130 as the signal source” means causing the vibrator 130 to vibrate and using an electric signal generated based on the vibration and having a predetermined frequency.

Based on the laser sensing signal S1, the light reception signal S2, and the reference signal Ss, the signal processor 15 measures the elapsed period Δt from the output of the first laser light L11 to the detection of the vibration VB.

To realize the function of calculating the elapsed period Δt out of the functions of the signal processor 15, for example, the preprocessor and the demodulator disclosed in JP-A-2022-038156 are used. The preprocessor performs preprocessing on the light reception signal S2 based on the reference signal Ss, and the demodulator demodulates the signal on which the preprocessing has been performed into the surface vibration signal based on the reference signal Ss.

When the ultrasonic wave US generated by the radiation of the first laser light L11 is reflected off the defect def shown in FIG. 1, the vibration VB is induced at the surface of the object under inspection 10. The vibration VB is accompanied by changes in the displacement and the speed of the displacement of the surface of the object under inspection 10. The signal processor 15 demodulates the surface vibration signal to extract the displacement of the surface of the object under inspection 10 and changes in the displacement speed, and detects the vibration VB. The vibration VB can thus be precisely detected in a noncontact manner. The signal processor 15 then measures the elapsed period Δt from the output of the first laser light L11 to the detection of the vibration VB. The elapsed period Δt reflects the propagation distance of the ultrasonic wave US for the period from the time when the ultrasonic wave US is generated to the time when the ultrasonic wave US is reflected off the defect def and reaches the surface. The signal processor 15 can accurately measure the elapsed period Δt by using the reference signal Ss as the time reference. Note that the elapsed period Δt can be calculated, for example, by counting the pulses of the reference signal Ss.

In the present embodiment, the pulse control signal Sd output from the frequency converter 118 is input as the laser sensing signal S1 to the signal processor 15. The photodiode 922 in the related art can therefore be omitted in the present embodiment. The laser sensing signal S1 is the same as the pulse control signal Sd, and therefore accurately reflects the timing at which the first laser light L11 is output. The signal processor 15 can therefore more accurately measure the elapsed period Δt.

FIG. 3 is a timing chart showing an example of the reference signal Ss input to the signal processor 15, a displacement d calculated from the light reception signal S2, the laser sensing signal S1, and an imaging control signal St.

The signal processing of each of the displacement d and the laser sensing signal S1 shown in FIG. 3 is performed based on (in synchronization with) the reference signal Ss. Specifically, for example, the signal processor 15 measures, based on the reference signal Ss, an elapsed period Δt1 from the rising edge (timing at which first laser light L11 is output) of a pulse S11 of the laser sensing signal S1 to the detection of a displacement d1 shown in FIG. 3. Similarly, an elapsed period Δt2 from the rising edge (timing at which first laser light L11 is output) of a pulse S12 to the detection of a displacement d2 is measured based on the reference signal Ss. The multiple types of signal processing are thus readily synchronized with each other, so that the elapsed periods Δt1 and Δt2 can be readily and accurately measured.

### 2.1.3. Imager

The imager 20 captures the irradiation position of the first laser light L11 and the object under inspection 10.

The drive control circuit provided in the imager 20 outputs the imaging control signal St shown in FIG. 3 based on the reference signal Ss. A control element provided in the imager 20 controls the exposure start timing and an exposure period E based on the imaging control signal St. For example, three exposure periods E are set in FIG. 3. The periods other than the exposure periods E are each a non-exposure period NE. Specifically, the timing of the rise of each of imaging control signals St1, St2, and St3 shown in FIG. 3 is the exposure start timing. The period from the rise to the fall of each of the imaging control signals St1, St2, and St3 is the exposure time E.

The exposure start timing is set at a point before the rise of the laser sensing signal S1 (before first laser light L11 is output). That is, the first laser light source 112 outputs the first laser light L11 after a predetermined period has elapsed since the imager 20 started exposure. The first laser light L11 is therefore irradiated during each of the exposure periods E, so that the irradiation position of the first laser light L11 can be reliably captured in an image acquired by the imaging element. The exposure start timing and the timing at which the first laser light L11 is irradiated may coincide with each other, but it is preferable to set the timings as described above in consideration of the possibility of a time lag from the rise of the laser sensing signal S1 to stabilization of the operation of the imaging element.

The exposure periods E are each set in accordance with the period for which the first laser light L11 is irradiated, that is, the pulse width and the pulse repetition cycle of the first laser light L11. An image acquired in a single exposure period E may record the irradiation positions of multiple pulses of the first laser light L11, but preferably records the irradiation position of one pulse of the first laser light L11. Therefore, when the pulse S11 of the laser sensing signal S1 shown in FIG. 3 rises and the first laser light L11 is output, it is preferable to quickly terminate the exposure. In this case, the irradiation position of one pulse can be recorded in an image, and a blur of the image due to the movement of the irradiation position during the exposure period E can be suppressed.

In the present embodiment, the output of the first laser light L11, and the exposure start timings and the exposure periods E in the imager 20 are controlled based on the reference signal Ss (by counting pulses of reference signal Ss), as shown in FIG. 3. A shift of any of the timings or the like is therefore unlikely to occur, so that an image capturing the irradiation position of the first laser light L11 can be reliably acquired. The inspection controller 6, which will be described later, can thus more accurately determine, based on the image, the irradiation position of the first laser light L11 in the object under inspection 10. As a result, whether the defect def is present in the object under inspection 10 and the position of the defect def can be detected more accurately. That is, the object under inspection 10 can be reliably inspected, and the precision of the inspection can be increased.

To realize the exposure periods E described above, the numerical value of the frame rate [fps] at which the imager 20 performs imaging may be set at a value greater than the numerical value of the repetition frequency [Hz] of the pulses of the first laser light L11. The pulse width of the first laser light L11 is, for example, about 10 [ns], and the laser oscillation is not performed in any time frame other than the pulse width. In this case, the exposure periods E may each be set at any period longer than the pulse width of the first laser light L11.

The imaging range of the imager 20 is set at a range over which the object under inspection 10 is inspected and which contains the irradiation position of the first laser light L11.

The optical axis of the first laser light L11 and the optical axis of the second laser light L12 may incline with respect to each other, but are preferably parallel to each other. The distance between the irradiation position of the first laser light L11 and the irradiation position of the second laser light L12, which are shown in FIG. 1, can thus be fixed even when the head unit 5 is moved with respect to the object under inspection 10. As a result, when the position of the defect def is calculated from the elapsed period Δt, it is not necessary to make corrections associated with a change in the distance between the irradiation positions, so that the amount of calculation is suppressed.

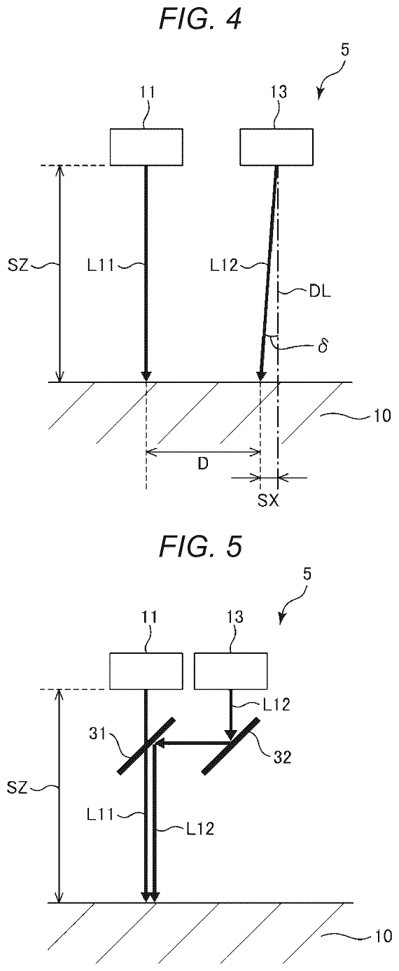

Note that the optical axes may not be parallel to each other to some extent. FIG. 4 is a diagrammatic view showing a state in which the optical axis of the second laser light L12 inclines by a deviation angle δ with respect to a reference line DL parallel to the optical axis of the first laser light L11.

In FIG. 4, SZ represents the distance from the head unit 5 to the object under inspection 10, and the optical axis of the second laser light L12 deviates from the reference line DL by the deviation angle δ. In this case, a deviation width SX between the reference line DL and the irradiation position of the second laser light L12 at the object under inspection 10 is preferably smaller than or equal to 3% of the distance SZ. The precision of the detection of the defect def can thus be sufficiently secured, and as a result, in the assembly of the laser induced ultrasonic inspection apparatus 1, required assembly precision can be relaxed.

Note that when the deviation width SX is smaller than or equal to 3% of the distance SZ, the deviation angle δ is smaller than or equal to 1.7°. Therefore, when the optical axes are not parallel to each other, the deviation angle δ shown in FIG. 4 is preferably smaller than or equal to 1.7°. A laser induced ultrasonic inspection apparatus 1 that is readily assembled can thus be achieved with the precision of the detection of the defect def sufficiently ensured.

In FIG. 4, D represents the distance between the optical axis of the first laser light L11 and the optical axis of the second laser light L12 at the surface of the object under inspection 10. The distance D is not limited to a specific value, but is preferably greater than or equal to 0 mm but smaller than or equal to 50 mm. The position of the defect def is therefore readily detected with increased precision.

Note that when the distance D is smaller than or equal to 10 mm, it is preferable that the wavelength of the first laser light L11 and the wavelength of the second laser light L12 differ from each other, more preferably, by a value greater than or equal to 30 nm. In this case, a decrease in the precision of the detection of the defect def can be suppressed even when the beam of the first laser light L11 and the beam of the second laser light L12 overlap with each other.

When the distance D is smaller than or equal to 10 mm, in particular, the optical axis of the first laser light L11 and the optical axis of the second laser light L12 may be made coaxial by using a coaxial optical system.

FIG. 5 is a diagrammatic view showing the case where the optical axis of the first laser light L11 and the optical axis of the second laser light L12 are made coaxial by using a coaxial optical system.

The coaxial optical system shown in FIG. 5 includes dichroic mirrors 31 and 32. The dichroic mirror 31 is disposed on the optical axis of the first laser light L11 and transmits the first laser light L11. The dichroic mirror 32 is disposed on the optical axis of the second laser light L12 and reflects the second laser light L12. The reflected second laser light L12 is reflected off the dichroic mirror 31 so as to coincide with the optical axis of the first laser light L11. The optical axis of the first laser light L11 and the optical axis of the second laser light L12 are thus made coaxial, so that the defect def can be detected even when the size of the object under inspection 10 is small.

At the irradiation position of the second laser light L12, the angle between a normal to the surface of the object under inspection 10 and the optical axis of the second laser light L12 is not limited to a specific value, but is preferably set at an angle smaller than or equal to 10°. That is, the optical axis of the second laser light L12 preferably extends in the direction perpendicular to the surface of the object under inspection 10 or a direction approximately perpendicular thereto. The second laser light L12 reflected off the object under inspection 10 therefore has a sufficient intensity and can be received by the vibration detector 13. In addition, even when the distance SZ from the head unit 5 to the object under inspection 10 changes, the distance D shown in FIG. 4 is unlikely to change, so that the amount of calculation required to calculate the position of the defect def can be suppressed.

### 2.1.4. Enclosure

The enclosure 52 does not necessarily have a specific size, but is preferably sized, for example, so as to fall within a 250-mm-square cube, more preferably, within a 200-mm-square cube in consideration of a situation in which the enclosure 52 is held by the operator. Furthermore, in consideration of a situation in which the enclosure 52 is held with one hand, it is more preferable that the enclosure 52 is sized so as to fall within a 150-mm-square cube.

The enclosure 52 shown in FIG. 1 includes a body 522, a first window 524, a second window 526, and an imaging window 528.

The body 522 is a rigid, box-shaped body. The material of which the body 522 is made is not limited to a specific material, and is selected as appropriate from, for example, a metal material and a resin material.

The first window 524 is so transmissive that the first laser light L11 can exit out of the enclosure 52. The first window 524 may be a through hole formed in the body 522, or may be a transparent window member fitted into the through hole. The second window 526 is so transmissive that the second laser light L12 can exit out of the enclosure 52. The second laser light L12 reflected off the object under inspection 10 enters the interior of the enclosure 52 via the second window 526. The second window 526 may be a through hole formed in the body 522, or may be a transparent window member fitted into the through hole.

The first window 524 and the second window 526 may be integrated with each other, but are preferably separate from each other as shown in FIG. 1. The configuration in which the two windows are separate from each other can prevent the second laser light L12 reflected off the object under inspection 10 from traveling back to the first laser light source 112, and the first laser light L11 reflected off the object under inspection 10 from being incident on the photodiode 136.

The imaging window 528 transmits visible light, infrared light, or the like so that the imager 20 can perform imaging. The imaging window 528 may be a through hole formed in the body 522, or may be a transparent window member fitted into the through hole.

Providing the thus configured enclosure 52 can improve the portability of the head unit 5. Furthermore, the housed elements can be protected from changes in external pressure and external environment. The first window 524, the second window 526, and the imaging window 528 may be provided as necessary, and may be omitted. In this case, a large through hole or window member may be provided so as to cover the first window 524, the second window 526, and the imaging window 528.

### 2.2. Overview of Inspection Controller

The inspection controller 6 shown in FIG. 1 includes an object recognition portion 62, a defect detector 64, and a storage 66.

The object recognition portion 62 performs object recognition on an image acquired by the imager 20. The defect detector 64 acquires, from the imager 20, multiple images showing different irradiation positions of the first laser light L11 and the second laser light L12 at the object under inspection 10. The irradiation positions at the object under inspection 10 are calculated based on the multiple images. The defect def contained in the object under inspection 10 is then detected based on the irradiation positions and the elapsed period Δt described above. The storage 66 stores the images acquired from the imager 20.

Note in the present embodiment that the inspection controller 6 is installed outside the enclosure 52, but the inspection controller 6 may be housed in the enclosure 52. In this case, the head unit 5 and the inspection controller 6 can both be portable.

### 2.2.1. Object Recognition Portion

The object recognition portion 62 performs object recognition on an image acquired by the imager 20. Object recognition involves the process of recognizing the position of an object shown in an image. Specifically, object recognition involves machine-learning-based detection of a specific object, pattern detection for detecting a pattern or a characteristic shape, and template matching based on similarity between an object under detection and a template image. The object recognition portion 62 can therefore acquire the coordinates of the position of the object under inspection 10 in the image. Based on the coordinates, the defect detector 64, which will be described later, can calculate a relative irradiation position P(X, Y) of the first laser light L11 and the second laser light L12 at the object under inspection 10.

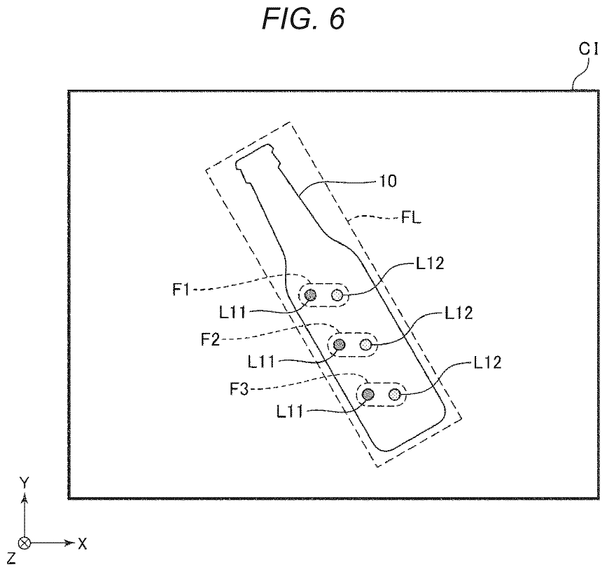

FIG. 6 shows an example of a combined image CI in a case where the object under inspection 10 is a bottle. The combined image CI is an image produced by combining multiple images acquired by the imager 20 with the positions of the object under inspection 10 in the multiple images caused to coincide with each other. The combined image CI shown in FIG. 6 shows an image of the bottle as the object under inspection 10 and a frame line FL, which indicates that the positions of the object under inspection 10 have been recognized. The combined image CI shown in FIG. 6 is produced by combining three images acquired by the imager 20 while moving the head unit 5 with respect to the object under inspection 10. The combined image CI therefore includes a beam image F1 of the first laser light L11 and the second laser light L12 extracted from the first image, a beam image F2 of the first laser light L11 and the second laser light L12 extracted from the second image, and a beam image F3 of the first laser light L11 and the second laser light L12 extracted from the third image.

The first laser light L11 and the second laser light L12 contained in the beam images F1, F2, and F3 have high brightness, so that the defect detector 64, which will be described later, can precisely detect the irradiation positions of the first laser light L11 and the second laser light L12. The defect detector 64 can therefore calculate the relative irradiation position P(X, Y) of the first laser beam L11 and the second laser beam L12 at the object under inspection 10.

Note that FIG. 6 shows a case where the entire bottle as the object under inspection 10 is captured, but only a portion of the bottle may be captured when the object under inspection 10 is large. In this case, as long as any feature point is captured instead of the contour of the object under inspection 10, the irradiation position P(X, Y) can be calculated based on the feature point.

The object recognition portion 62 may have the function of generating the combined image CI described above as necessary.

The object recognition portion 62 may be provided as necessary. For example, when the relative size and position of the object under inspection 10 with respect to the imager 20 are fixed, the position of the object under inspection 10 in an image is also known, so that the object recognition portion 62 may be omitted. Even when the position of the object under inspection 10 is not recognized, the imager 20 acquires an image containing the irradiation position of the first laser light L11, so that the irradiation position at the object under inspection 10 can be identified later based on the irradiation position shown in the image. On the other hand, even when the relative size and position of the object under inspection 10 with respect to the imager 20 are not fixed, providing the object recognition portion 62 allows identification of the position of the object under inspection 10 in an image, so that the convenience of the inspection can be increased.

### 2.2.2. Defect Detector

The defect detector 64 acquires, from the imager 20, multiple images showing different irradiation positions of the first laser light L11 and the second laser light L12 at the object under inspection 10. The multiple images are acquired, for example, with the head unit 5 moved with respect to the object under inspection 10, as described above. The head unit 5 may be moved by a mover that is not shown, or the operator may move the head unit 5 while holding the head unit 5. The thus acquired multiple images separately show the beam images F1, F2, and F3 of the first laser light L11 and the second laser light L12 with which the object under inspection 10 is irirradiated at different positions, as shown in FIG. 6. The defect detector 64 calculates the relative irradiation position P(X, Y) of the first laser light L11 and the second laser light L12 at the object under inspection 10 from the relative positions of the beam images F1, F2, and F3.

Note that when the optical axes of the first laser light L11 and the second laser light L12 are fixed and are parallel or approximately parallel to each other, the relationship between the irradiation positions of the first laser light L11 and the second laser light L12 can be regarded as a known relationship. Therefore, it is sufficient that at least the irradiation position of the first laser light L11 is captured in each image, but it is preferable that the irradiation position of the second laser beam L12 is also captured.

At the timing when the beam images F1, F2, and F3 are captured, the signal processor 15 measures the elapsed period Δt corresponding to the position of each of the beam images F1, F2, and F3. The defect detector 64 then acquires multiple data sets of the irradiation position P(X, Y) at the object under inspection 10 and the elapsed period Δt, and detects the defect def contained in the object under inspection 10 based on the acquired data sets. Since the elapsed period Δt reflects the position of the point where the ultrasonic wave US is reflected, whether the defect def is present and the position thereof can be determined based on the elapsed period Δt. An example of a method for determining the position of the defect def from multiple data sets will be described below.

When the object under inspection 10 is irirradiated with the first laser light L11 at different positions, the difference between the elapsed period Δt1 and the elapsed period Δt2 shown in FIG. 3 reflects the relationship between the irradiation positions of the first laser light L11 and the position of the defect def shown in FIG. 1. The first laser light L11 is irradiated while the relative position of the head unit 5 with respect to the object under inspection 10 is changed, followed by measurement of the elapsed period Δt, and calculation of the irradiation position P(X, Y) of each of the first laser light L11 and the second laser light L12 at the object under inspection 10. The position of the defect def can thus be identified. A specific example of the procedure described above will be described below.

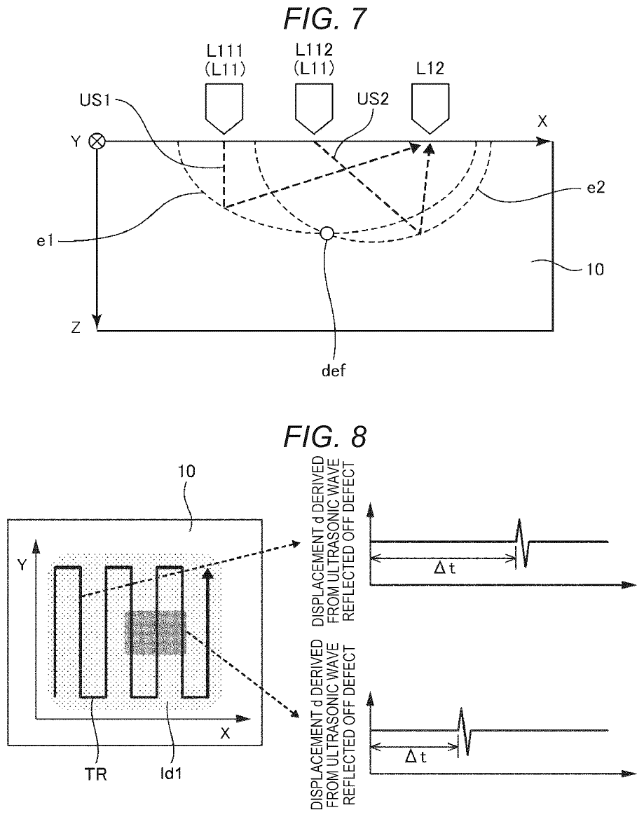

FIG. 7 is a diagrammatic view showing propagation of ultrasonic waves US1 and US2 induced when first laser light L111 and first laser light L112 are irradiated onto two different locations at the surface of the object under inspection 10. When the first laser light L111 is irradiated, the ultrasonic wave US1 propagates along a large number of trajectories including that shown in FIG. 7. Part of the ultrasonic wave US1 is then reflected off the defect def and reaches the surface. The ultrasonic wave US1 having reached the surface is detected by the second laser light L12, for example, in the form of displacement (vibration) of the surface. Similarly, the first laser light L112 induces the ultrasonic wave US2 propagating along a large number of trajectories including that shown in FIG. 8. Part of the ultrasonic wave US2 is then reflected off the defect def and reaches the surface. The ultrasonic wave US2 having reached the surface is detected by the second laser light L12, for example, in the form of displacement (vibration) of the surface.

FIG. 3 shows an example of the waveforms of the displacement d1 derived from the ultrasonic wave US1 reflected off the defect def and the displacement d2 derived from the ultrasonic wave US2 reflected off the defect def. Since the irradiation positions of the first laser light L111 and the first laser light L112 differ from each other, the elapsed periods Δt1 and Δt2 spent until the displacement d1 and the displacement d2 are detected also differ from each other, as shown in FIG. 3. The defect detector 64 therefore has the function of determining that the defect def is present, for example, when an elapsed period Δt set in advance is shorter than or equal to a reference value of the elapsed period Δt based on the reference value. Note that the defect detector 64 may have the function of determining whether the defect def is present based on another method.

The propagation speeds of the ultrasonic waves US1 and US2 can be acquired in advance based on the material and other factors of the object under inspection 10 or through actual measurement. The propagation distances of the ultrasonic waves US1 and US2 can therefore be calculated from the elapsed periods Δt1 and Δt2 and the propagation speeds. The case where the ultrasonic wave US1 propagates for the calculated propagation distance indicates that the defect def is present somewhere on an ellipse e1 shown in FIG. 7. Similarly, the case where the ultrasonic wave US2 propagates for the calculated propagation distance indicates that the defect def is present somewhere on an ellipse e2 shown in FIG. 7. Based on the principle described above, the position of the defect def in FIG. 7 can be identified by irradiating the object under inspection 10 at least at three irradiation positions with the first laser light L11.

Therefore, when images showing at least the three beam images F1, F2, and F3 can be acquired as shown in FIG. 6, the defect detector 64 can identify the position of the defect def based on the above principle. Since the aforementioned detection of the defect def can be performed in a non-destructive manner, the laser induced ultrasonic inspection apparatus 1 can perform a non-destructive inspection of the object under inspection 10. The distribution of the defects def can be acquired by two-dimensionally scanning the object under inspection 10 with the head unit 5.

Note that examples of the material of which the object under inspection 10 is made may include concrete, metal, resin, ceramic, and glass. Furthermore, examples of the defect def may include a void, a crack, a flake, an interface, foreign matter, and a modified portion.

The defect detector 64 may have the function of creating a defect distribution map showing the distribution of the defects def contained in the object under inspection 10. The defect distribution map can visually show the result of the inspection of the object under inspection 10. Creating the defect distribution map can contribute to assisting the understanding of the result of the inspection.

Specifically, the defect detector 64 creates a defect distribution map by using a data set of the irradiation position P(X, Y) at the object under inspection 10 and the elapsed period Δt as point group data.

FIG. 8 shows an example of a scanning-operation trajectory TR of the irradiation position of the first laser light L11 as a result of scanning the object under inspection 10 with the first laser light L11, and an example of a defect distribution map Id1 produced by replacing the length of the elapsed period Δt on the scanning-operation trajectory TR with a color density and mapping the color density. FIG. 8 also shows examples of the waveform of the displacement d acquired at two locations where the color densities differ from each other in the defect distribution map Id1.

The scanning-operation trajectory TR shown in FIG. 8 is a trajectory drawn when the irradiation position of the first laser light L11 is shifted in the X-axis direction while being moved back and forth in the Y-axis direction. In the defect distribution map Id1 shown in FIG. 8, the color density is low when the elapsed period Δt is relatively long, and the color density is high when the elapsed period Δt is relatively short. Generating the defect distribution map Id1 described above allows visual indication of the defect def is present, the position, depth, and other factors of the defect def.

The laser induced ultrasonic inspection apparatus 1 shown in FIG. 1 may include a display that is not shown but displays the defect distribution map Id1 created as described above. Examples of the display may include a liquid crystal display apparatus, an organic EL display apparatus, and an image projection apparatus. Note that the display may display not only the defect distribution map Id1 but an image acquired by the imager 20 superimposed thereon. The superimposed image can assist understanding of the correspondence between the position of the defect def and the object under inspection 10.

### 2.2.3. Storage

The storage 66 temporarily stores the multiple images acquired from the imager 20. The defect detector 64 can therefore calculate the irradiation position P(X, Y) of each of the first laser light L11 and the second laser light L12 at the object under inspection 10 while suppressing a temporary increase in the amount of calculation in the defect detector 64. The function of the storage 66 is achieved by a memory that will be described later.

### 2.3. Hardware Configuration

The functions of the signal processor 15, the object recognition portion 62, and the defect detector 64 are achieved, for example, by hardware including a CPU, a memory, and an interface. The hardware is, for example, a microcomputer. The term CPU is an abbreviation for “central processing unit”. Examples of the memory may include any nonvolatile storage (ROM), any volatile storage (RAM), and a detachable external storage. Examples of the interface may include a digital input/output port such as a universal serial bus (USB). The functions of the signal processor 15, the object recognition portion 62, and the defect detector 64 are each achieved by the CPU executing a program loaded in advance in the memory. Note that the method in which the CPU executes the program to realize the functions described above may be replaced with or may be combined with a method in which a field programmable gate array (FPGA), an application specific integrated circuit (ASIC), or any other integrated circuit, discrete parts, or the like realizes the functions described above.

In the present embodiment, the vibration of the vibrator 130 is used to perform the light modulation (modulation of frequency of second laser light L12), the demodulation of the surface vibration signal, the control of the imaging performed by the imager 20, the generation of the pulse control signal Sd, and the measurement of the elapsed period Δt as described above, and the number of parts is reduced accordingly. The head unit 5 includes the enclosure 52, which houses the pulse laser irradiator 11, the vibration detector 13, the imager 20, and the like. A laser induced ultrasonic inspection apparatus 1 that is readily reduced in size and excels in portability can thus be achieved. Furthermore, using the same reference signal Ss as the time reference allows easy and accurate synchronization of multiple types of signal processing. The laser induced ultrasonic inspection apparatus 1 can therefore inspect the object under inspection 10 with increased precision.

### 3. Second Embodiment

A laser induced ultrasonic inspection apparatus according to a second embodiment will next be described.

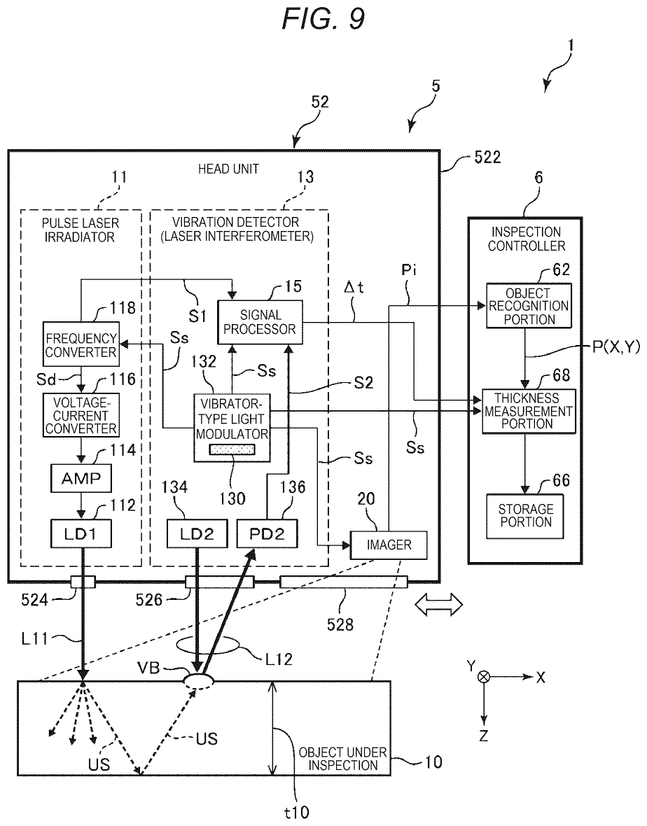

FIG. 9 is a diagrammatic view showing a schematic configuration of a laser induced ultrasonic inspection apparatus 1 according to the second embodiment.

The second embodiment will be described below. In the following description, differences from the first embodiment will be primarily described, and substantially the same items will not be described. Note that elements that are substantially the same as those in the first embodiment described above have the same reference characters in FIG. 9.

The laser induced ultrasonic inspection apparatus 1 according to the second embodiment is substantially the same as the laser induced ultrasonic inspection apparatus 1 according to the first embodiment except that a thickness t10 of the object under inspection 10 is measured in the second embodiment.

The inspection controller 6 shown in FIG. 9 includes a thickness measurement portion 68 in place of the defect detector 64 shown in FIG. 1. In the laser induced ultrasonic inspection apparatus 1 shown in FIG. 9, when one surface of the object under inspection 10 is irirradiated with the first laser light L11, and the induced ultrasonic wave US is reflected off the other surface of the object under inspection 10, then returns to the one surface again, and induce the vibration VB there, the vibration VB is detected by the second laser light L12. In this case, the elapsed period Δt from the output of the first laser light L11 to the detection of the vibration VB reflects the thickness t10 of the object under inspection 10. That is, let V be the propagation speed of the ultrasonic wave US, and the thickness t10 is determined by Expression (1) below.

t10=V·Δt/2 (1)

Note that Expression (1) described above is satisfied in the strict sense when the optical axis of the first laser light L11 and the optical axis of the second laser light L12 are coaxial. Therefore, when the two axes are not coaxial, correction may be made based on the separation distance between the two axes and the propagation distance of the ultrasonic wave US calculated from the elapsed period Δt.

The thickness t10 described above can be calculated by the thickness measurement portion 68. The laser induced ultrasonic inspection apparatus 1 can therefore inspect the thickness t10 of the object under inspection 10 in a non-destructive manner.

In addition, calculating the thickness t10 while changing the relative position of the head unit 5 with respect to the object under inspection 10 allows the thickness measurement portion 68 to create a thickness distribution map. Creating the defect distribution map can contribute to assisting the understanding of the result of the inspection.

The second embodiment described above also provides substantially the same advantages as those provided by the first embodiment.

### 4. Third Embodiment

A laser induced ultrasonic inspection apparatus according to a third embodiment will next be described.

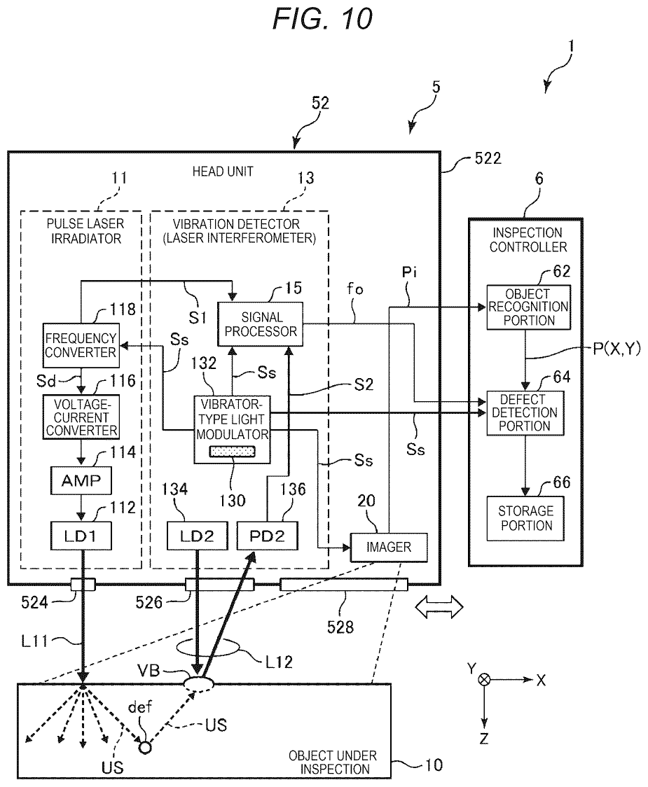

FIG. 10 is a diagrammatic view showing a schematic configuration of a laser induced ultrasonic inspection apparatus 1 according to the third embodiment.

The third embodiment will be described below. In the following description, differences from the first embodiment will be primarily described, and substantially the same items will not be described. Note that elements that are substantially the same as those in the first embodiment described above have the same reference characters in FIG. 10.

The laser induced ultrasonic inspection apparatus 1 according to the third embodiment is substantially the same as the laser induced ultrasonic inspection apparatus 1 according to the first embodiment except that the signal processor 15 is configured to calculate the frequency of the vibration VB based on the reference signal Ss.

The signal processor 15 shown in FIG. 10 captures the displacement and the speed of the displacement generated at the surface of the object under inspection 10 produced in association with the vibration VB. The vibration VB can thus be detected.

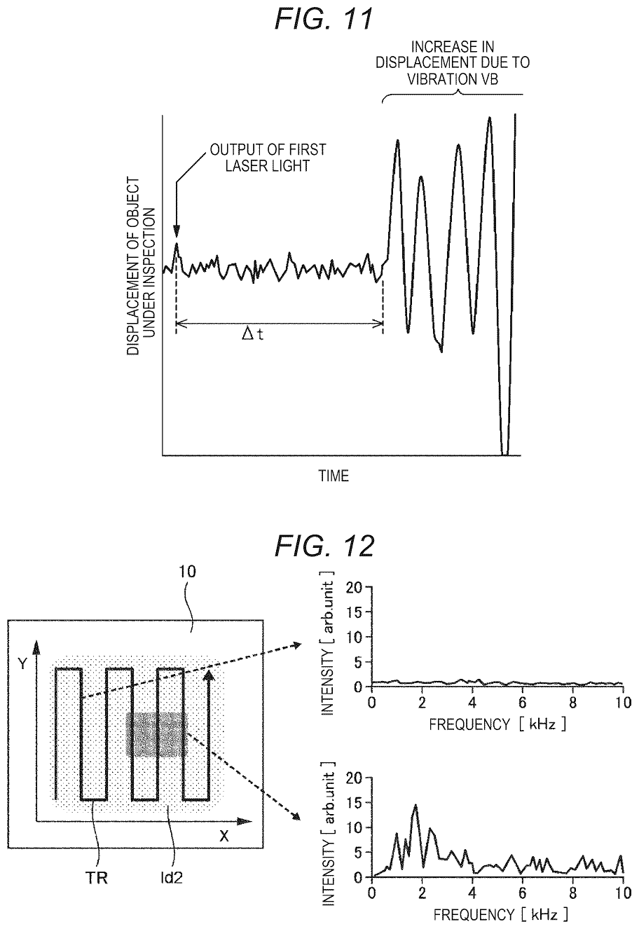

FIG. 11 is a graph showing the waveform of the displacement of the object under inspection 10 produced in association with the vibration VB. In FIG. 11, the horizontal axis represents time, and the vertical axis represents the displacement of the object under inspection 10.

In the graph shown in FIG. 11, almost no displacement is recognized during the elapsed period Δt from the output of the first laser light L11 to the detection of the vibration VB as the displacement of the surface of the object under inspection 10. On the other hand, the amplitude of the displacement increases after the elapsed period Δt. The vibration VB can be detected based on the behavior of the displacement described above.

The signal processor 15 shown in FIG. 10 has the function of capturing the temporal waveform of the displacement having increased due to the vibration VB shown in FIG. 11 and performing frequency analysis of the temporal waveform. Note that the temporal waveform of the displacement speed may be captured in place of the temporal waveform of the displacement. The frequency analysis can be fast Fourier analysis. The signal processor 15 performs the frequency analysis to generate a frequency analysis result fo. The frequency analysis result fo contains the intensity on a frequency component basis, that is, resonance frequency information and the like. Note that since the temporal waveform of the displacement is generated based on the reference signal Ss, a highly precise frequency analysis result fo is produced.

In the present embodiment, the defect detector 64 acquires multiple of data sets of the irradiation position P(X, Y) at the object under inspection 10 and the frequency analysis result fo. The defect detector 64 then detects the defect def contained in the object under inspection 10 based on the acquired data sets. Since the frequency analysis result fo reflects the frequency specific to the defect def, whether the defect def is present and the position thereof can be determined based on the frequency analysis result fo. The object under inspection 10 can thus be inspected in a non-destructive manner.

The defect detector 64 may have the function of creating a defect distribution map by using data sets of the irradiation position P(X, Y) at the object under inspection 10 and the frequency analysis result fo as point group data.

FIG. 12 shows an example of the scanning-operation trajectory TR of the irradiation position of the first laser light L11 as a result of scanning the object under inspection 10 with the first laser light L11, and an example of a defect distribution map Id2 produced by replacing the frequency analysis result fo on the scanning-operation trajectory TR with a color density and mapping the color density. FIG. 12 also shows examples of the waveform of the frequency analysis result fo acquired at two locations where the color densities differ from each other in the defect distribution map Id2.

In the defect distribution map Id2 shown in FIG. 12, when the intensities at a frequency of about 2 kHz and in the vicinity thereof are smaller than a predetermined threshold, the color densities are low, and when the intensities are greater than or equal to the predetermined threshold, the color densities are high by way of example. Generating the defect distribution map Id2 described above allows visual indication of whether the defect def is present, the position of the defect def, the resonance frequency information, and the like.

The third embodiment described above also provides advantages that are substantially the same as those provided by the first embodiment.

Furthermore, in the present embodiment, the vibration of the vibrator 130 is used to perform the light modulation, the demodulation of the surface vibration signal, the generation of the pulse control signal Sd, the control of the imaging performed by the imager 20, and the generation of the temporal waveforms of the displacement and the displacement speed, and the number of parts is reduced accordingly.

### 5. Fourth Embodiment

A display apparatus including a laser induced ultrasonic inspection apparatus will next be described as a fourth embodiment.

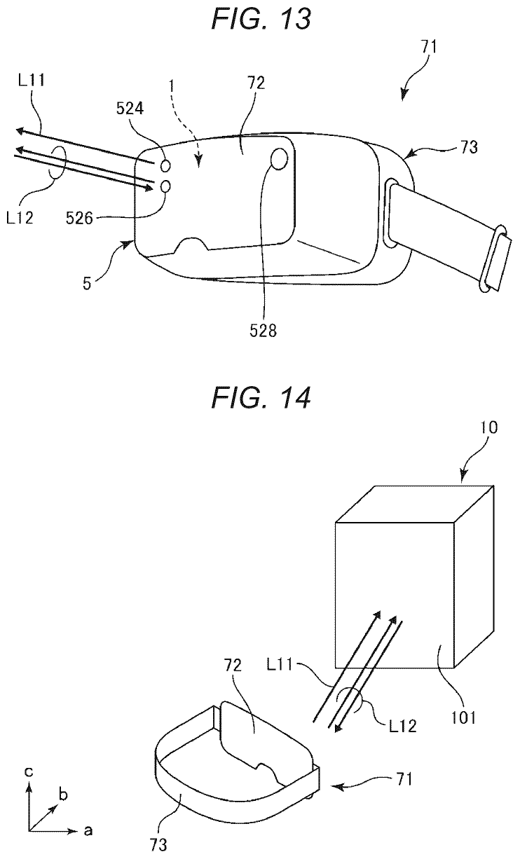

FIG. 13 is a diagrammatic view showing a schematic configuration of a display apparatus 71 according to the fourth embodiment.

The fourth embodiment will be described below. In the following description, differences from the first embodiment will be primarily described, and substantially the same items will not be described. Note in FIGS. 13 and 14 that the elements that are substantially the same as those in the first embodiment have the same reference characters.

The display apparatus 71 shown in FIG. 13 is a head-mounted display and includes the laser induced ultrasonic inspection apparatus 1 and a display 72. The display 72 includes a transmissive display panel, and is configured to display the defect distribution maps Id1 and Id2 described above and the like and allow see-through viewing of an outside scenery. In addition, an image acquired by the imager 20, a result of the object recognition performed by the object recognition portion 62, and the like may be displayed as necessary.

The display apparatus 71 is mounted on the head of a person. The display 72 is thus disposed in front of the eyes of the person.

The display apparatus 71 shown in FIG. 13 further includes a mounting portion 73. The mounting portion 73 is configured with a pad, a belt, or the like that fixes the laser induced ultrasonic inspection apparatus 1 and the display 72 to the head of the person.

In the display apparatus 71 shown in FIG. 13, the head unit 5 provided in the laser induced ultrasonic inspection apparatus 1 is disposed at a front surface (surface on front side when viewed from person). The first window 524, the second window 526, and the imaging window 528 are therefore exposed to the front surface.

FIG. 14 is a perspective view showing a state in which the display apparatus 71 shown in FIG. 13 is used to inspect the object under inspection 10. The object under inspection 10 shown in FIG. 14 has a cuboid shape, and one of the outer surfaces thereof is called a front surface 101. In FIGS. 14 to 16, three axes perpendicular to each other are called an a-axis, a b-axis, and a c-axis. The front surface 101 is a surface perpendicular to the b-axis.

When an operator wearing the display apparatus 71 looks straight at the front surface 101 and moves the head to scan the front surface 101, the irradiation position of the first laser light L11 is also scanned. The object under inspection 10 can thus be inspected along the front surface 101.

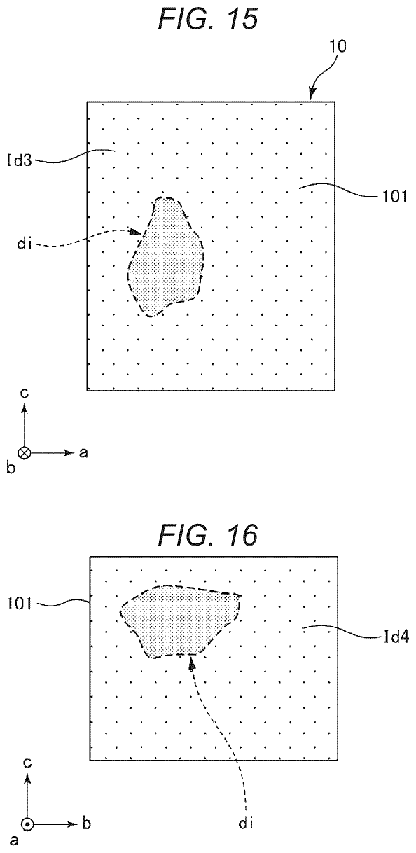

FIG. 15 shows an example of a defect distribution map Id3 displayed on the display 72 shown in FIG. 13, and the object under inspection 10 viewed through the display 72 and superimposed on the defect distribution map Id3.

The defect distribution map Id3 shown in FIG. 15 visually shows a defect distribution di in the directions in the plane (directions in a-c plane) of the front surface 101. Displaying the defect distribution map Id3 with a real image of the object under inspection 10 superimposed thereon can assist intuitive understanding of the defect distribution di.

FIG. 16 is an example of a defect distribution map Id4 displayed on the display 72 shown in FIG. 13.

The defect distribution map Id4 shown in FIG. 16 visually shows the defect distribution di in a b-axis direction (depth direction) extending from the front surface 101. Displaying the defect distribution map Id4 described above on the display 72 of the head-mounted display allows the operator, for example, to grasp the defect distribution di even at the site where the inspection is performed.

In the laser induced ultrasonic inspection apparatus 1 according to each of the embodiments described above, reduction in size, weight, and power consumption is achieved. The laser induced ultrasonic inspection apparatus 1 can therefore also be readily incorporated into a device that is mounted on a human body and operated with an internal power supply, like the display apparatus 71.

The fourth embodiment described above also provides substantially the same advantages as those provided by the first embodiment.

Note that the display apparatus according to the present disclosure is not limited to that described above, and may, for example, be a liquid crystal display apparatus, an organic EL display apparatus, or an image projection apparatus.

### 6. Fifth Embodiment

An electronic instrument including a laser induced ultrasonic inspection apparatus will next be described as a fifth embodiment.

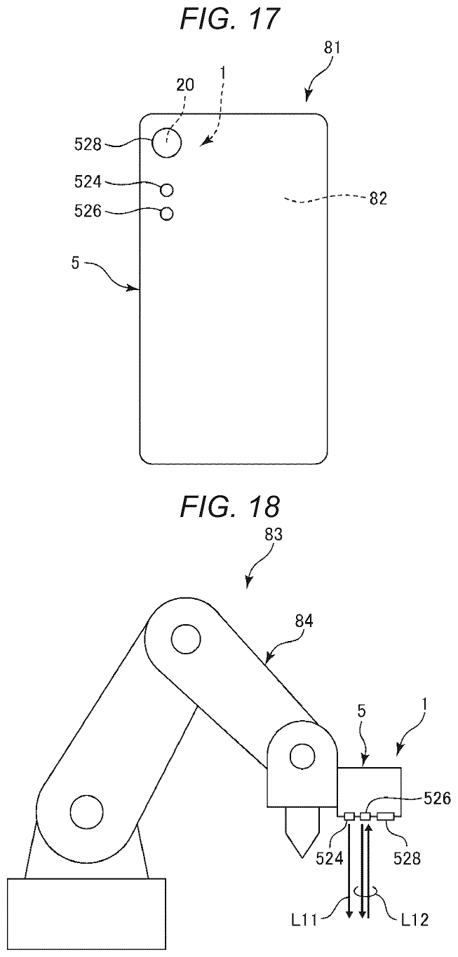

FIG. 17 is a diagrammatic view showing a schematic configuration of an electronic instrument 81 according to the fifth embodiment. FIG. 18 is a diagrammatic view showing a schematic configuration of an electronic instrument 83 according to the fifth embodiment.

The fifth embodiment will be described below. In the following description, differences from the first embodiment will be primarily described, and substantially the same items will not be described. Note in FIGS. 17 and 18 that the elements that are substantially the same as those in the first embodiment have the same reference characters.

The electronic instrument 81 shown in FIG. 17 is a smartphone and includes the laser induced ultrasonic inspection apparatus 1 and a display 82. Examples of the display 82 may include a liquid crystal display apparatus and an organic EL display apparatus. The display 82 displays, for example, the defect distribution maps Id1 and Id2 described above. In addition, an image acquired by the imager 20, a result of the object recognition performed by the object recognition portion 62, and the like may be displayed as necessary.

An operator who holds the electronic instrument 81 can inspect the object under inspection 10 by relatively scanning the object under inspection 10 with the electronic instrument 81.

In the electronic instrument 81 shown in FIG. 17, the first window 524, the second window 526, and the imaging window 528 are exposed to the front surface of the electronic instrument 81. Note that the imager 20 described above may be used for a purpose different from the inspection of the object under inspection 10 in application software executed by the smartphone.

The thus configured electronic instrument 81, which is a smartphone used in daily life and incorporating the laser induced ultrasonic inspection apparatus 1, can inspect the object under inspection 10 more easily.

The electronic instrument 83 shown in FIG. 18 is an industrial robot, and includes a robot arm 84 and the head unit 5 of the laser induced ultrasonic inspection apparatus 1 attached to the distal end of the robot arm 84. The robot arm 84 can change its posture in accordance, for example, with a program. The head unit 5 can thus be automatically placed at a target position in any posture. As a result, the object under inspection 10 can be automatically scanned with the head unit 5, so that the object under inspection 10 can be automatically inspected.

The fifth embodiment described above also provides substantially the same advantages as those provided by the first embodiment.

Note that the electronic instrument according to an aspect of the present disclosure is not limited to that described above, and may, for example, be a tablet terminal or a wearable device. Since the laser induced ultrasonic inspection apparatus 1 is small, an increase in the size of the electronic instrument that incorporates the laser induced ultrasonic inspection apparatus 1 can be suppressed.

### 7. Sixth Embodiment

A vehicle including a laser induced ultrasonic inspection apparatus will next be described as a sixth embodiment.

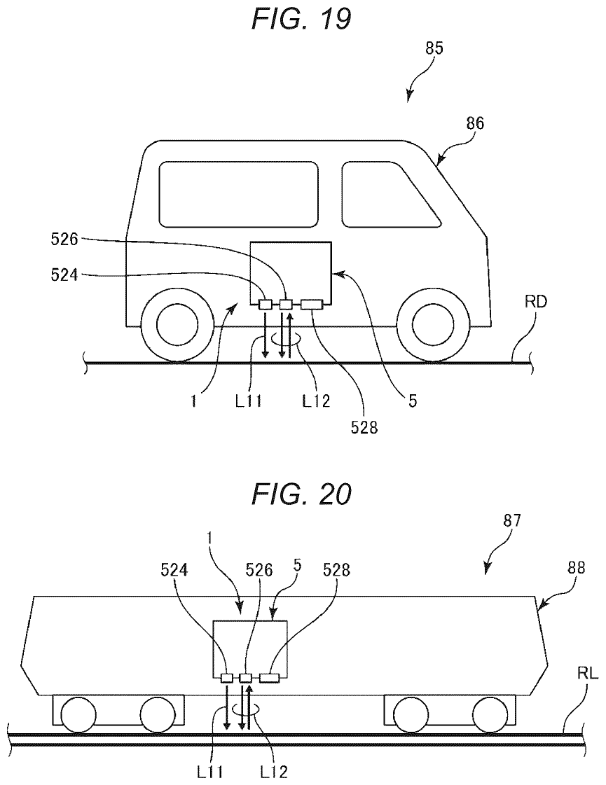

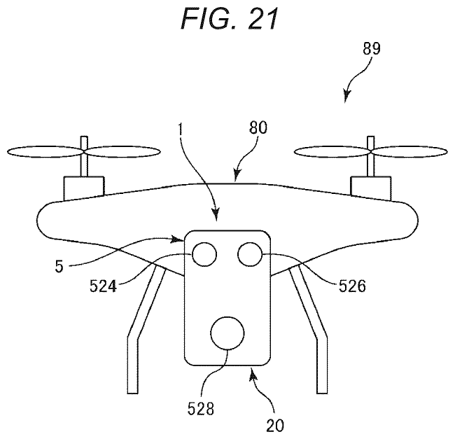

FIG. 19 is a diagrammatic view showing a schematic configuration of a vehicle 85 according to the sixth embodiment. FIG. 20 is a diagrammatic view showing a schematic configuration of a vehicle 87 according to the sixth embodiment. FIG. 21 is a diagrammatic view showing a schematic configuration of a vehicle 89 according to the sixth embodiment.

The sixth embodiment will be described below. In the following description, differences from the first embodiment will be primarily described, and substantially the same items will not be described. Note in FIGS. 19 and 20 that the elements that are substantially the same as those in the first embodiment have the same reference characters.

The vehicle 85 shown in FIG. 19 is a roadbed inspection vehicle, and includes a vehicle body 86, which is an automobile, and the laser induced ultrasonic inspection apparatus 1. The laser induced ultrasonic inspection apparatus 1 is attached to the vehicle body 86 so as to output the first laser light L11 and the second laser light L12 toward a roadbed RD and capture the roadbed RD.

When the vehicle 85 travels along the roadbed RD, the roadbed RD is scanned with the first laser light L11, so that the roadbed RD, which is the object under inspection, can be efficiently inspected. Note that the inspection target is not limited to the roadbed RD, and may, for example, be a wall of a tunnel, a soundproof wall, a retaining wall, a bridge girder, a bridge pier, or other structures.

The vehicle 87 shown in FIG. 20 is a railroad inspection and measurement car, and includes a car body 88, which is a railroad vehicle, and the laser induced ultrasonic inspection apparatus 1. The laser induced ultrasonic inspection apparatus 1 is attached to the car body 88 so as to output the first laser light L11 and the second laser light L12 toward a railroad track RL and capture the railroad track RL.

When the vehicle 87 travels along the railroad track RL, the railroad track RL is scanned with the first laser light L11, so that the railroad track RL, which is the object under inspection, can be efficiently inspected. Note that the inspection target is not limited to the railroad track RL, and may, for example, be a wall of a tunnel, a soundproof wall, a retaining wall, a bridge girder, a bridge pier, or other structures.

The vehicle 89 shown in FIG. 21 is a drone, and includes an airframe 80 and the head unit 5 of the laser induced ultrasonic inspection apparatus 1. The laser induced ultrasonic inspection apparatus 1, which is reduced in size, weight, power consumption, and the like as described above, can minimize the influence of the head unit 5 on the flight performance even when the head unit 5 is attached to the airframe 80.

When the vehicle 89 flies along a structure or the like that is not shown, the structure is scanned with the first laser light L11, so that the structure or the like, which is the object under inspection, can be efficiently inspected. The inspection target is not limited to a specific object, and may be a high-altitude place, a dangerous place, a high radiation area, or the like that a person cannot easily approach.

The sixth embodiment described above also provides substantially the same advantages as those provided by the first embodiment.

Note that the vehicle according to the present disclosure is not limited to those described above, and may, for example, be a bicycle, a motorcycle, a ship, or a self-propelled robot.

### 8. Advantages Provided by Embodiments Described Above

The laser induced ultrasonic inspection apparatus 1 according to any of the embodiments includes the first laser light source 112, the vibration detector 13 (laser interferometer), the imager 20, and the enclosure 52, as described above. The first laser light source 112 irradiates the object under inspection 10 with the pulse-shaped first laser light L11. The vibration detector 13 uses the second laser light L12 to detect the vibration VB of the object under inspection 10 derived from the ultrasonic wave US induced in the object under inspection 10 by the radiation of the first laser light L11. The imager 20 captures the irradiation position of the first laser light L11 and the object under inspection 10. The enclosure 52 houses the first laser light source 112, the vibration detector 13, and the imager 20.

The vibration detector 13 includes the second laser light source 134, the light modulator 132, and the photodiode 136 (light receiver). The second laser light source 134 irradiates the object under inspection 10 with the second laser light L12. The light modulator 132 uses the vibrator 130 to modulate the frequency of the second laser light L12. The photodiode 136 receives the interference light between the second laser light L12 having traveled via the object under inspection 10 and the second laser light L12 having traveled via the light modulator 132, and outputs the light reception signal S2.

The vibrator 130 also serves as the signal source of the reference signal Ss. The first laser light source 112 outputs the first laser light L11 based on the reference signal Ss. The imager 20 performs imaging based on the reference signal Ss.

The configuration described above allows the laser induced ultrasonic inspection apparatus 1 to have a small number of parts, to be readily reduced in size, and to excel in portability. The thus configured laser induced ultrasonic inspection apparatus 1 can be held, for example, by an operator or can be readily attached to an electronic instrument, a vehicle, or the like.

In the laser induced ultrasonic inspection apparatus 1 according to any of the embodiments, the imager 20 may start exposure based on the reference signal Ss. Furthermore, the first laser light source 112 may output the first laser light L11 based on the reference signal Ss after a predetermined period has elapsed since the imager 20 started exposure.

According to the configuration described above, even when there is a time lag from the rise of the laser sensing signal S1 to the stabilization of the operation of the imaging element, the irradiation position of the first laser light L11 can be reliably captured in an image acquired by the imaging element.

In the laser induced ultrasonic inspection apparatus 1 according to any of the embodiments, it is preferable that the optical axis of the first laser light L11 irradiated onto the object under inspection 10 and the optical axis of the second laser light L12 irradiated onto the object under inspection 10 are parallel to each other.

According to the configuration described above, even when the head unit 5 is moved with respect to the object under inspection 10, the distance between the irradiation position of the first laser light L11 and the irradiation position of the second laser light L12 can be kept constant. As a result, for example, when the position of the defect def is calculated from the elapsed period Δt, it is not necessary to make corrections associated with a change in the distance between the irradiation positions, so that the amount of calculation is suppressed.

In the laser induced ultrasonic inspection apparatus 1 according to any of the embodiments, the enclosure 52 may include the first window 524 and the second window 526. In this case, the first window 524 causes the first laser light L11 to exit out of the enclosure 52. The second window 526 causes the second laser light L12 to exit out of the enclosure 52. The first window 524 and the second window 526 are separate from each other.

The configuration described above, in which the two windows are separate from each other, can prevent the second laser light L12 reflected off the object under inspection 10 from traveling back to the first laser light source 112, and the first laser light L11 reflected off the object under inspection 10 from being incident on the photodiode 136.

In the laser induced ultrasonic inspection apparatus 1 according to any of the embodiments, the vibration detector 13 (laser interferometer) includes the signal processor 15, which detects the vibration VB based on the light reception signal S2. The signal processor 15 detects the vibration VB by demodulating the surface vibration signal from the light reception signal S2 based on the reference signal Ss.

The configuration described above, in which the reference signal Ss can be used to demodulate the surface vibration signal from the light reception signal S2, can contribute to reduction in the number of parts of the laser induced ultrasonic inspection apparatus 1.

In the laser induced ultrasonic inspection apparatus 1 according to any of the embodiments, the signal processor 15 may measure the elapsed period Δt from the output of the first laser light L11 to the detection of the vibration VB based on the reference signal Ss.

The configuration described above, in which the reference signal Ss can be used as the time reference to measure the elapsed period Δt, can contribute to reduction in the number of parts of the laser induced ultrasonic inspection apparatus 1.

The laser induced ultrasonic inspection apparatus 1 according to any of the embodiments may include the defect detector 64, which detects the defect def contained in the object under inspection 10. In this case, the defect detector 64 acquires, from the imager 20, multiple images showing different irradiation positions of the first laser light L11 at the object under inspection 10, calculates the irradiation position at the object under inspection 10 based on the multiple images, and detects the defect def contained in the object under inspection 10 based on the irradiation position and the elapsed period Δt.

The configuration described above allows the laser induced ultrasonic inspection apparatus 1 to be capable of calculating the elapsed period Δt from the multiple images to detect the defect def only by scanning the object under inspection 10 with the first laser light L11 so as to scan the irradiation position thereof.

The laser induced ultrasonic inspection apparatus 1 according to any of the embodiments may include the thickness measurement portion 68, which measures the thickness t10 of the object under inspection 10 based on the result of the measurement of the elapsed period Δt.

The configuration described above allows the laser induced ultrasonic inspection apparatus 1 to be capable of measuring the thickness t10 only by scanning the object under inspection 10 with the first laser light L11 so as to scan the irradiation position thereof.

In the laser induced ultrasonic inspection apparatus 1 according to any of the embodiments, the signal processor 15 may calculate the frequency of the detected vibration VB based on the reference signal Ss.

The configuration described above, in which the reference signal Ss can be used as the time reference to calculate the frequency of the vibration VB, can contribute to reduction in the number of parts of the laser induced ultrasonic inspection apparatus 1.

The laser induced ultrasonic inspection apparatus 1 according to any of the embodiments may include the defect detector 64, which detects the defect def contained in the object under inspection 10. In this case, the defect detector 64 acquires, from the imager 20, multiple images showing different irradiation positions of the first laser light L11 at the object under inspection 10, calculates the irradiation position at the object under inspection 10 based on the multiple images, and detects the defect def contained in the object under inspection 10 based on the irradiation position and the frequency of the vibration VB.

The configuration described above allows the laser induced ultrasonic inspection apparatus 1 to be capable of calculating the frequency of the vibration VB from the multiple images to detect the defect def only by scanning the object under inspection 10 with the first laser light L11 so as to scan the irradiation position thereof.

In the laser induced ultrasonic inspection apparatus 1 according to any of the embodiments, the defect detector 64 may generate the defect distribution maps Id1 and Id2 showing the defect distribution di of defects contained in the object under inspection 10.

The configuration described above allows the laser induced ultrasonic inspection apparatus 1 to visually indicate whether the defect def is present, and the position, the depth, and other factors of the defect def.

The laser induced ultrasonic inspection apparatus 1 according to any of the embodiments may include the object recognition portion 62, which recognizes the object under inspection 10 by detecting the object under inspection 10 in the images. In this case, the defect detector 64 calculates the irradiation position of the first laser light L11 at the object under inspection 10 based on the result of the recognition of the object under inspection 10 made by the object recognition portion 62.

According to the configuration described above, the coordinates of the position of the object under inspection 10 in the image can be acquired. Even when the relative size and position of the object under inspection 10 with respect to the imager 20 are not fixed, the position of the object under inspection 10 in the image can be identified, so that the convenience of the inspection can be enhanced.

The laser induced ultrasonic inspection apparatus 1 according to any of the embodiments may include the storage 66, which stores an image acquired from the imager 20.

The configuration described above allows calculation of the irradiation position P(X, Y) of each of the first laser light L11 and the second laser light L12 at the object under inspection 10 while suppressing a temporary increase in the amount of calculation in the defect detector 64.

The display apparatus 71 according to the embodiment includes the laser induced ultrasonic inspection apparatus 1 according to any of the embodiments, and the display 72, which displays the defect distribution maps Id1 and Id2 (distribution maps of defects def detected by laser induced ultrasonic inspection apparatus 1).

The configuration described above allows the display apparatus 71 to assist intuitive understanding of the defect distribution di.

The electronic instruments 81 and 83 according to the embodiment each include the laser induced ultrasonic inspection apparatus 1 according to any of the embodiments.

The configuration described above allows the electronic instrument 81 to inspect the object under inspection 10, for example, by the operator holding the head unit 5 and relatively scanning the object under inspection 10 with the head unit 5, and the electronic instrument 83 to automatically inspect the object under inspection 10 by causing the robot arm 84 to operate the head unit 5.

The vehicles 85, 87, and 89 according to the embodiment each include the laser induced ultrasonic inspection apparatus 1 according to any of the embodiments.

The configuration described above allows each of the vehicles 85, 87, and 89 to travel to scan an object under inspection with the first laser light L11 for efficient inspection of the object under inspection.

The laser induced ultrasonic inspection apparatus, the display apparatus, the electronic instrument, and the vehicle according to the embodiments of the present disclosure have been described above with reference to the drawings, but the present disclosure is not limited thereto.

For example, the laser induced ultrasonic inspection apparatus, the display apparatus, the electronic instrument, and the vehicle according to the embodiments of the present disclosure may be provided by replacing each portion in any of the embodiments described above with any constituent element having substantially the same function, or may be provided by adding any constituent element to any of the embodiments described above. In addition, the laser induced ultrasonic inspection apparatus according to any of the embodiments of the present disclosure may have a configuration that is a combination of two or more of the embodiments described above.

What is claimed is:

1. A laser induced ultrasonic inspection apparatus comprising:
a first laser light source configured to irradiate an object under inspection with pulse-shaped first laser light;
a laser interferometer configured to detect, by using second laser light, vibration of the object under inspection derived from an ultrasonic wave induced in the object under inspection by the radiation of the first laser light;
an imager configured to capture an image including irradiation position of the first laser light and the object under inspection; and
an enclosure configured to house the first laser light source, the laser interferometer, and the imager,
wherein the laser interferometer includes
a second laser light source configured to irradiate the object under inspection with the second laser light,
a light modulator configured to modulate a frequency of the second laser light by using a vibrator; and
a light receiver configured to receive the second laser light traveling via the object under inspection and the second laser light traveling via the light modulator and output a light reception signal,
the vibrator is a signal source of a reference signal,
the first laser light source is configured to output the first laser light based on the reference signal, and
the imager is configured to capture the image based on the reference signal.

2. The laser induced ultrasonic inspection apparatus according to claim 1, wherein
the imager is configured to start exposure based on the reference signal, and
the first laser light source is configured to output the first laser light based on the reference signal after a predetermined period elapses, the predetermined period starts when the imager starts the exposure.

3. The laser induced ultrasonic inspection apparatus according to claim 1, wherein
an optical axis of the first laser light irradiated onto the object under inspection and an optical axis of the second laser light irradiated onto the object under inspection are parallel to each other.

4. The laser induced ultrasonic inspection apparatus according to claim 3, wherein
the enclosure includes
a first window configured to cause the first laser light to exit out of the enclosure, and
a second window configured to cause the second laser light to exit out of the enclosure, and
the first window and the second window are separate from each other.

5. The laser induced ultrasonic inspection apparatus according to claim 1, wherein
the laser interferometer includes a signal processor configured to detect the vibration based on the light reception signal,
the signal processor is configured to detect the vibration by demodulating a surface vibration signal from the light reception signal based on the reference signal.

6. The laser induced ultrasonic inspection apparatus according to claim 5, wherein
the signal processor is configured to measure an elapsed period from the output of the first laser light to the detection of the vibration based on the reference signal.

7. The laser induced ultrasonic inspection apparatus according to claim 6, further comprising
a defect detector configured to detect a defect contained in the object under inspection,
wherein the defect detector is configured to
acquire, from the imager, multiple images showing the irradiation positions different from each other at the object under inspection,
calculate the irradiation position at the object under inspection based on the multiple images, and
detect the defect contained in the object under inspection based on the irradiation position and the elapsed period.

8. The laser induced ultrasonic inspection apparatus according to claim 6, further comprising:
the signal processor is configured to measure a thickness of the object under inspection based on a result of the measurement of the elapsed period.

9. The laser induced ultrasonic inspection apparatus according to claim 5, wherein
the signal processor is configured to calculate a frequency of the detected vibration based on the reference signal.

10. The laser induced ultrasonic inspection apparatus according to claim 9, wherein
a defect detector configured to detect a defect contained in the object under inspection,
the defect detector is configured to
acquire, from the imager, multiple images showing the irradiation positions different from each other at the object under inspection,
calculate the irradiation position at the object under inspection based on the multiple images, and
detect the defect contained in the object under inspection based on the irradiation position and the frequency of the vibration.

11. The laser induced ultrasonic inspection apparatus according to claim 7, wherein
the defect detector is configured to generate a defect distribution map showing a distribution of the defects contained in the object under inspection.

12. The laser induced ultrasonic inspection apparatus according to claim 7, wherein
the signal processor is configured to recognize the object under inspection by detecting the object under inspection in the images,
the defect detector is configured to calculate the irradiation position at the object under inspection based on a result of the recognition of the object under inspection.

13. The laser induced ultrasonic inspection apparatus according to claim 1, further comprising a storage configured to store an image acquired from the imager.

14. A display apparatus comprising:
the laser induced ultrasonic inspection apparatus according to claim 1; and
a display configured to display a distribution map of defects detected by laser induced ultrasonic inspection apparatus.

15. An electronic instrument comprising the laser induced ultrasonic inspection apparatus according to claim 1.

16. A vehicle comprising the laser induced ultrasonic inspection apparatus according to claim 1.
